(19) United States
(12) Patent Application Publication
(10) Pub. No.: US 2014/0188611 A1
(43) Pub. Date: Jul. 3, 2014

(54) COMBINATION OF MULTIPLE ADVERTISEMENTS IN AN AD SLOT ON A NETWORK ACCESSIBLE DEVICE

(71) Applicant: Google Inc., (US)

(72) Inventors: Ping Wu, Saratoga, CA (US); Zhenyu Liu, San Jose, CA (US)

(73) Assignee: Google Inc., Mountain View, CA (US)

(21) Appl. No.: 13/728,847

(22) Filed: Dec. 27, 2012

(51) Int. Cl. G06Q 30/02

(52) U.S. Cl. CPC G06Q 30/0257
USPC 705/14.55; 705/14.73; 705/14.71

(57) ABSTRACT

Apparatus and method for managing a combination of multiple advertisements in an ad slot on a network accessible device. In accordance with some embodiments, a request is received in a memory for a mobile advertisement (ad) for display in an ad slot on a graphical user interface (GUI) of a network accessible device. A total plural number of ads are selected from a database of available ads in a memory responsive to a size of the ad slot on the GUI. A combined ad is rendered that combines the total plural number of selected ads. The combined ad is transferred for display in the ad slot.

### BACKGROUND

Mobile applications (“mobile apps”) are a class of software routines executable on various types of portable network accessible devices such as smart phones, tablets, netbooks, PDAs, smart televisions, gaming systems, etc. Some mobile applications (“preinstalled apps” or “native apps”) are installed into the device during device manufacturing. Other mobile apps (“user installed apps” or “downloaded apps”) are selectively downloadable by a user, allowing the user to customize the device based on personal preferences. User installed mobile apps can take a variety of forms such as games, communication programs, daily planners, ebook readers, geopositioning trackers, alert systems, etc.

Mobile apps are often created by developers and offered for download through an online source such as an “app store.” Developers may offer mobile apps for free or for a nominal amount, and rely on other mechanisms such as embedded advertising (e.g., “mobile ads”) to generate revenue to cover the cost of the mobile app development.

### SUMMARY

Various embodiments disclosed herein are generally directed to managing a combination of multiple advertisements in an ad slot on a network accessible device.

In accordance with some embodiments, a request is received in a memory for a mobile advertisement (ad) for display in an ad slot on a graphical user interface (GUI) of a network accessible device. A total plural number of ads are selected from a database of available ads in a memory responsive to a size of the ad slot on the GUI. A combined ad is rendered that combines the total plural number of selected ads. The combined ad is transferred for display in the ad slot.

These and other features and advantages, which may characterize various embodiments, can be understood in view of the following detailed discussion and the accompanying drawings.

### BRIEF DESCRIPTION OF THE DRAWINGS

FIG. 1 provides a functional block representation of a network based system in accordance with various embodiments.

FIG. 2 shows aspects of the system of FIG. 1 in accordance with some embodiments.

FIG. 3 shows various example factors that may go into the selection of a combined ad.

FIG. 4 illustrates different example combined ads in a given slot size (2, 3 or 4).

FIG. 5 is a combined landing page in accordance with various embodiments.

FIG. 6 is an individual landing page format in accordance with various embodiments.

FIG. 7 shows example server-side modules that operate to render a combined ad.

FIG. 8 provides a flow chart for a routine illustrative of steps that may be carried out in accordance with various embodiments.

### DETAILED DESCRIPTION

The present disclosure generally relates to managing a combination of multiple advertisements in an ad slot on a network accessible device, and more particularly to managing the combination of multiple ads for different mobile apps tailored for a particular user of a first mobile app.

It is becoming increasingly common to display interactive content items, such as advertisements or other sponsored content, within the context of a currently executing mobile app. Configuring an application to accept such items may lead to increased revenue opportunities for the developer of the app.

Some mobile ads include a creative portion which may involve text, graphics, images or video files associated with the advertised service and/or product. Mobile ads displayed in mobile applications may offer an upgrade to the existing mobile app, or may offer other mobile apps that are available from the developer. In addition, the mobile ads may be for third party mobile applications, products or services not directly associated with the developer of the mobile app.

Mobile ads may further have an interactive portion such that user selection (a “click”) of the advertisement will direct the user to additional information related to the advertisement. The interactive portion of an ad can take a variety of forms. For example, advertisements can be configured such that, upon selection, the user is connected to a linked web page with additional information, often referred to as a “landing page.” Some advertisements may have forms or fields to “pre-load” searches or other operations on the landing page associated with the ad.

Other advertisements may have a “click to call” feature that enables a user to call (establish a telephonic connection with) the advertiser directly from the ad via clicking on a virtual button. Still other advertisements may have a “click to chat” feature that opens a chat window directly from a virtual link or button on the advertisement creative to enable the user to chat with a representative associated with the ad.

A “click to buy” feature allows users to carry out a purchase transaction for an advertised product or service. Similarly, a “click to download” feature can initiate a transaction that takes the user to an app store to purchase the advertised app.

These and other interactive ad formats may present one advertisement at a time in an advertisement slot. The one advertisement may not interest the user, such that the user does not “click” on the advertisement, which may mean the user does not receive the advertiser's full message, the developer loses a revenue opportunity, etc. Users may come to ignore the advertisement slot because the one advertisement routinely does not spark their interest, and may not follow up and pursue the download of a new app presented in the advertisement slot.

Accordingly, various embodiments of the present disclosure are generally directed to an apparatus and method for managing a combination of multiple advertisements in an ad slot on a network accessible device tailored for a particular user of a first mobile app. As explained below, during the execution of a mobile app, the user is presented with an interactive content item that presents a combination of advertisements that invites the user to take action, such as in the form of a mobile ad. The interactive content item is configured such that the user can receive a plurality of advertisements in the ad slot in the existing mobile app.

This simultaneous presentation of multiple advertisements to the user may increase the likelihood that at least one of the advertisements is selected, or “clicked”, by the user. This may increase the chances that the advertiser delivers their full message to the user, the developer captures a revenue opportunity, etc.

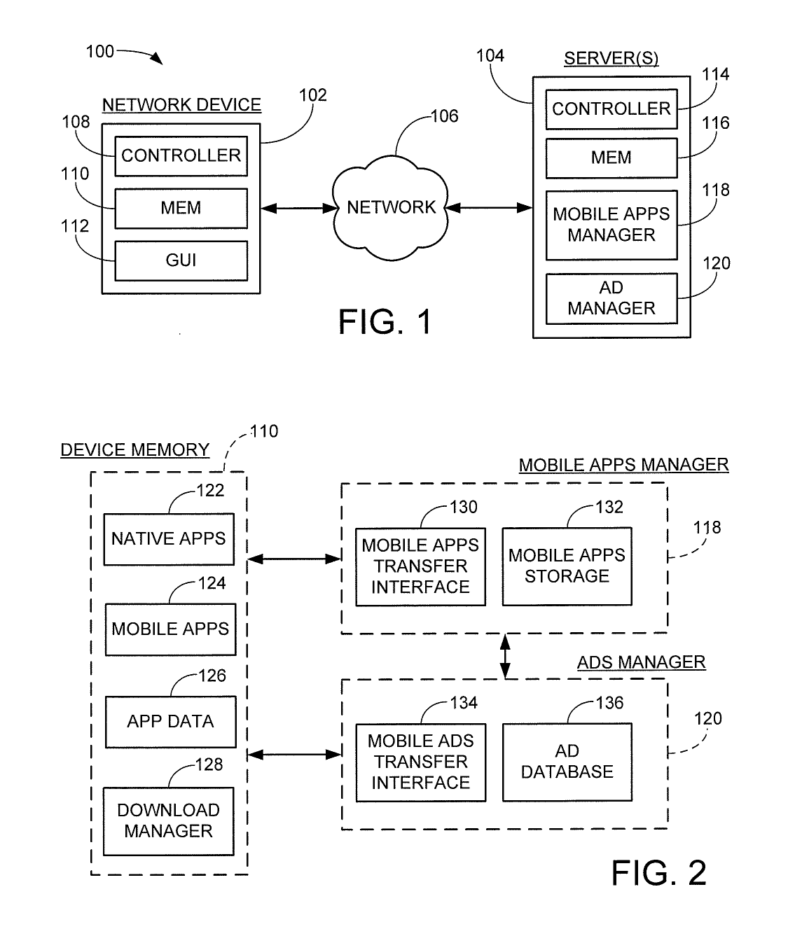

These and other features and benefits can be understood beginning with a review of FIG. 1 which depicts a network based, dynamic content transfer system 100 constructed and operated in accordance with various embodiments. The system 100 includes a number of components including a mobile network accessible device 102 and one or more servers 104. The device 102 and server(s) communicate over a network 106, such as a wide area network (WAN), a local area network (LAN), a broadband wireless network, etc.

The network accessible device 102 can take a variety of forms, including but not limited to a laptop computer, a tablet, a smart phone, or some other portable network accessible appliance adapted to download and execute mobile apps. The device 102 is shown to include a controller 108, local memory (mem) 110 and a graphical user interface (GUI) 112. Other components may be incorporated into the device.

The controller 108 may be a hardware based or programmable processor which provides top level control of the device responsive to inputs supplied by a user of the device via the GUI 112. The device memory 110 stores information input by the user, programming and/or control information utilized by the controller 108, and information transferred to the device over the network 106.

The GUI 112 may include a keyboard, keypad, mouse, monitor, touch screen, touch pad, microphone, game controller, and/or other suitable components to enable human comprehensible interaction with and/or control of the device. It is contemplated although not necessarily required that the execution of a downloaded mobile app from the memory 110 can be executed by user interaction with the GUI 112, and the resulting execution of the mobile app will display interactive A/V content on the GUI 112.

The server 104 can take a variety of forms, and is shown in FIG. 1 to include a controller 114, server memory (mem) 116, a mobile apps manager 118, and an ad manager 120. It will be appreciated that the managers 118, 120 may be realized in hardware, software and/or firmware, and may reside on the same server or on distinct servers each having associated controllers and memory spaces to facilitate intercommunication via the network 106. Thus, while only a single network accessible device 102, and a single server 104 are shown in FIG. 1, it will be appreciated that any number of respective devices and servers can be interconnected and utilized in accordance with the present disclosure.

As explained below, a user of the device 102 can access the server(s) 104 to download a mobile app from the mobile apps manager 118 to local device memory 110. During subsequent execution of the mobile app, the ad manager 120 may supply one or more mobile ads (or other interactive content items) responsive to requests for such by the mobile app.

FIG. 2 illustrates aspects of the system 100 of FIG. 1 in accordance with some embodiments. The device memory 110 may be a contiguous memory space or made up by a single memory device such as a solid-state memory array or a disc-based memory. Alternatively, the device memory 110 may represent various memory devices within the mobile device 102, including such elements as main memory, a hierarchical cache, I/O data buffers and local processor (L1-L3) cache. The memory 110 may be volatile, non-volatile, or a combination of both. The memory stores various operational modules including native applications (apps) 122, user downloaded mobile apps 124, application (app) data space 126, and a download manager 128. Other programming layers, such as a device operating system, may also be provided as desired.

The native apps 122 will vary depending on the configuration of the device 100 and generally represent software routines loaded onto and supplied with the device by the manufacturer. In some embodiments, the native apps 122 may include routines such as web browsers (e.g., Safari, etc.), telephone communication routines, video/still camera software, weather alert routines, word processing applications, clock and timing utilities, calculator displays, interface links to app stores, and so on.

The mobile apps 124 represent software routines specifically downloaded by the user for use on the device. The mobile apps can take a variety of forms including games, communication programs (e.g., third party email, chat and texting systems, etc.), daily planners, ebook readers, geopositioning trackers, alert systems, and so on. Both the native apps 122 and the user downloaded apps 124 may be represented on the GUI 112 (FIG. 1) as icons that are individually selectable by the user as desired.

The app data space 126 represents a portion of the local memory 110 allocated for the storage of control data associated with the respective execution of the native and downloaded mobile apps. Segregated data areas may be provided for these respective types of apps; for example, separate caches, history and cookie areas may be maintained for the various apps, both by type (native v. user) and on an individual app basis. Device level data, such as unique device identification values (e.g., a “device ID”) may also be stored in the app data space 126. Depending on device configuration, the user may or may not have direct access to the app data stored in the app data space, and may or may not be able to delete, alter or overwrite data stored therein.

The download manager 128 presents a download mechanism that manages the download of apps and data to the device memory 110.

The mobile apps manager 118 is shown in FIG. 2 to include a mobile apps transfer interface block 130 and a mobile apps storage space 132. Other modules can readily be incorporated. The interface block 130 generally operates to facilitate data transfers with the device 100, including the downloading of requested mobile apps from the storage space 132 and the servicing of requests for data from the device associated with the execution of the mobile apps. The mobile apps storage space 132 represents a storage area for a number of different mobile apps available for download to the device, such as through an application provider (“app store”). The mobile apps storage 132 may be provided via a cloud computing and storage system and may interface with a variety of third party suppliers of applications to provide the various available mobile apps.

The ads manager 120 includes a mobile ads transfer interface block 134 and an ad database 136. The ad manager 120 generally operates to receive requests for mobile ads and, in response thereto, proceeds to select and transfer one or more appropriate ads from the mobile ad database 136 for display on the local device 102. As before, the ads manager 120 may incorporate a number of additional modules including cloud computing and storage capabilities.

For purposes of providing a concrete example, it is contemplated in FIG. 2 that a selected mobile app has been selected for download by the user of the device 102 to the mobile apps memory block 124. The selection process may be a result of the user responding to a mobile ad presented in another, previously downloaded mobile app, or through some other mechanism such as through one of the native apps. For example, the user may have requested the download by accessing a link in the native apps to a particular app store associated with the mobile apps manager 118.

The successful download of the selected mobile app results in the display of an associated icon on the GUI 112 of the local device 102. User selection of the icon commences the execution of the selected mobile app. User termination of the selected mobile app may occur by the user selecting an exit button presented within the display of the selected mobile app, or by user selection of a power down or exit button on the device. While not limiting, it is contemplated that the selected mobile app will constitute an interactive game that involves user manipulation of animated characters presented on the GUI.

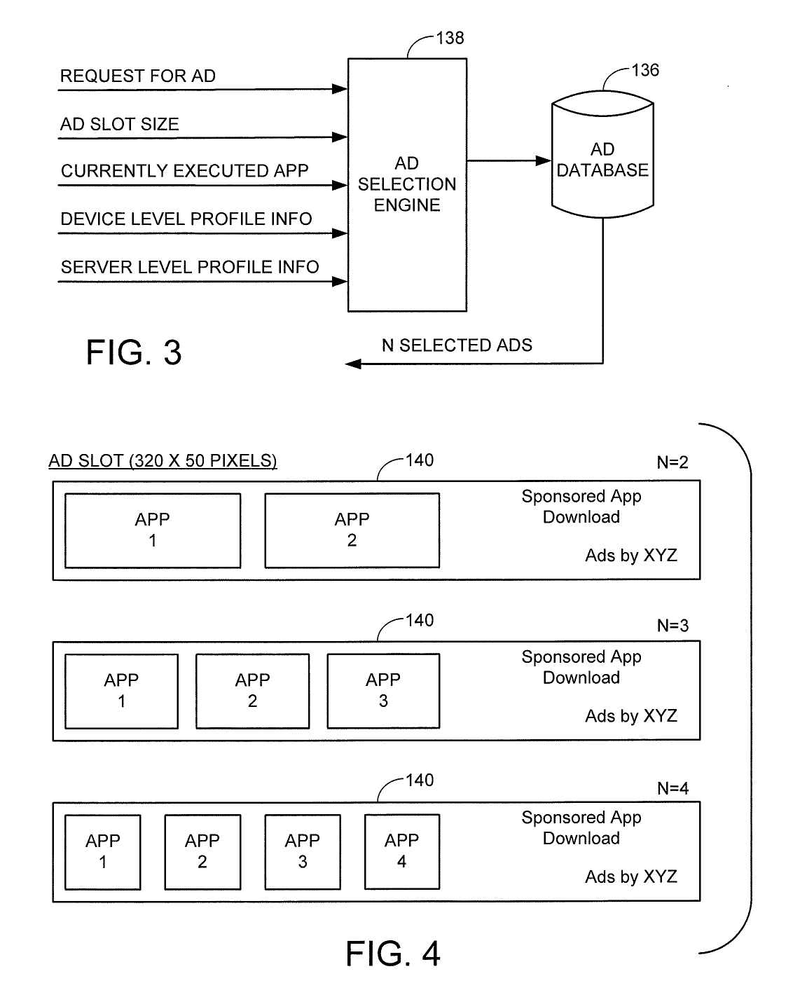

FIG. 3 shows various example factors that may go into the selection of N ads for the combined ad, e.g., N is a natural number greater than 1. A request for advertisement (ad) may be generated responsive to execution of the selected mobile app on the network accessible device 102 (FIG. 1). The size of the ad slot may be a factor used in the selection of the N selected ads.

The currently executed application may be a factor in the selection of ads. For example, the category of the selected mobile app, such as finance, game, map, geopositioning, and etc. could be used to select the type of advertisement to deliver to the user. Or the developer of the selected mobile app may choose to make the user aware of the developer's other mobile apps. Of course, one can see that any information related to the selected mobile app is used could be used in the selection process for the N selected ads.

The ads may be selected for the combined ad responsive to the device level profile information, such as device identification, device usage pattern, other apps installed on the device, app usage patterns, non-personal-identifiable information about the user such as demographics, geopositioning, and preferred language, or other suitable information. The device level profile may be transmitted with the request for advertisement.

Further, the ads may be selected for the combined ad responsive to server level profile information, such as server identification, server usage pattern, or other suitable information. The server level profile may be associated with the device.

These and other suitable selection factors may be input to an ad selection engine 138 that interacts with the ad database 136 to provide the N selected ads.

FIG. 4 illustrates different example combined ads 140 in a given slot size, such as 2, 3 or 4 ads per ad slot. The ad slot size can be nominally 320 pixels by 50 pixels, 640 pixels by 100 pixels, or other suitable size. The ads (such as “app 1”, “app 2”, “app 3”, “app 4”, etc.) can be scaled, as needed, for display in the combined ad 140 of the ad slot. The combined ad may have a plurality of interactive action portions, at least one interactive action portion for each of the selected ads.

In addition, one or more of the interactive portions of the plurality of interactive action portions could be in relation to combination information that may not applicable if the ads are displayed individually. For example, the combined ads 140 could display text related to multiple ads, such as “buy app 1 and app 2, get 20% discount”, “buy app 1, receive app 2 free!”

It will be noted that the combined ad 140 in FIG. 4 includes the phrase “Ads by XYZ.” While not necessarily required, a communication to the user such as this may provide the user with information regarding the sponsor for an app download. Of course, the combined ads may have more than one sponsor for each individual ad or the combined ads 140 as a whole.

The combined ad may be displayed responsive to a request communication generated by the execution of the selected mobile app. This request may be directed to the mobile apps manager 118 and forwarded to the ads manager 120, or may be transferred directly to the ads manager 120 by the device 102. Regardless, processing of the communication results in the transmission and display of the combined ad 140 from the ad database 136 (see FIG. 2).

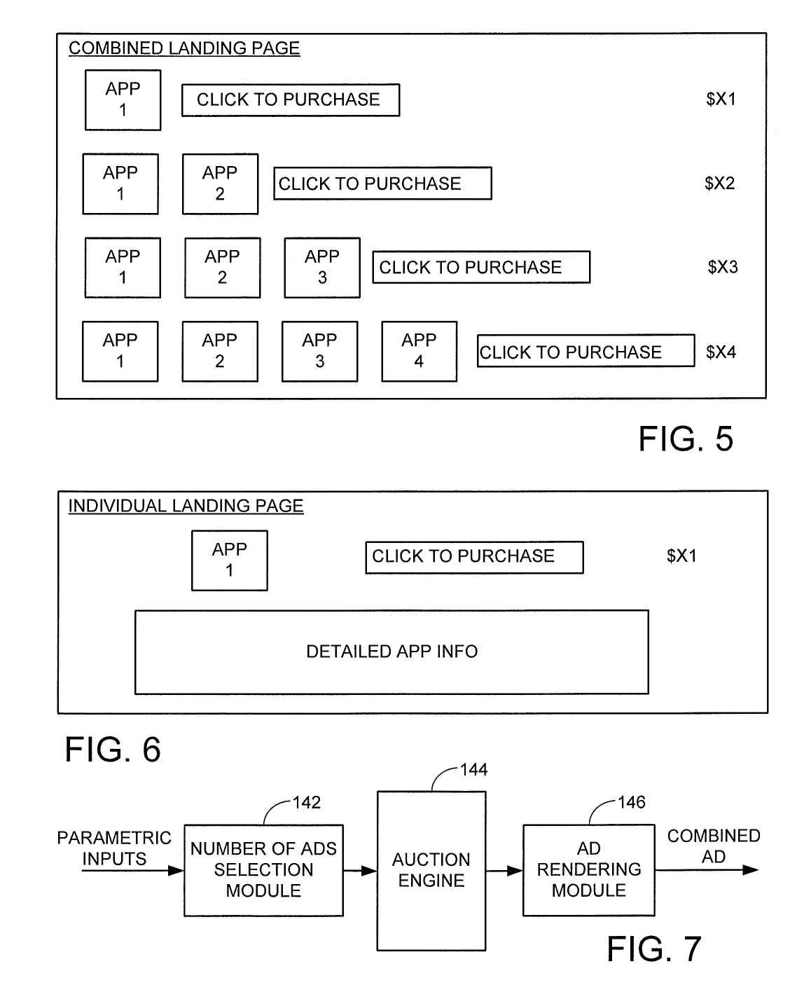

FIG. 5 shows a combined landing page in accordance with various embodiments. As previously mentioned, advertisements can be configured such that, upon selection, the user is connected to a linked web page with additional information, often referred to as a “landing page.” In addition, some advertisements may have forms or fields to “pre-load” searches or other operations on the landing page associated with the ad.

A cost-to-click value (e.g., $X1, $X2, SX3, and $X4) may be assigned to each landing page. App 1, app 2, app 3, app 4 may be assigned a different click-to-cost value in relation to a presentation order, such as the leftmost position having more value than the rightmost position, or vice versa depending on language used on the page, etc. Of course, any relative value system could be established to set the cost-to-click value in any presentation order. A landing page may be generated for display on the device GUI responsive to user selection of the combined ad. The landing page may extend a plurality of invitations to action by the user for different combinations of the selected ads in the combined ad established responsive to user selection of the combined ad.

Based on appropriate parametric inputs, a combined landing page may be selected for display through the GUI 112 on the device 102 (see FIG. 1). Each individual app on the combined landing page may have an associated individual landing page as depicted in FIG. 6 that shows an individual landing page format in accordance with various embodiments. A different landing page may be displayed responsive to user selection of different ones of the plurality of interactive action portions.

As an example, the user might click one of the interactive portions in relation to combination information, such that the ads manager 120 (see FIG. 1) may receive combination information, such as special Uniform Resource Locator (URL) parameters. The combination information may enable downloading multiple apps together with one install click for the multiple apps, for instance.

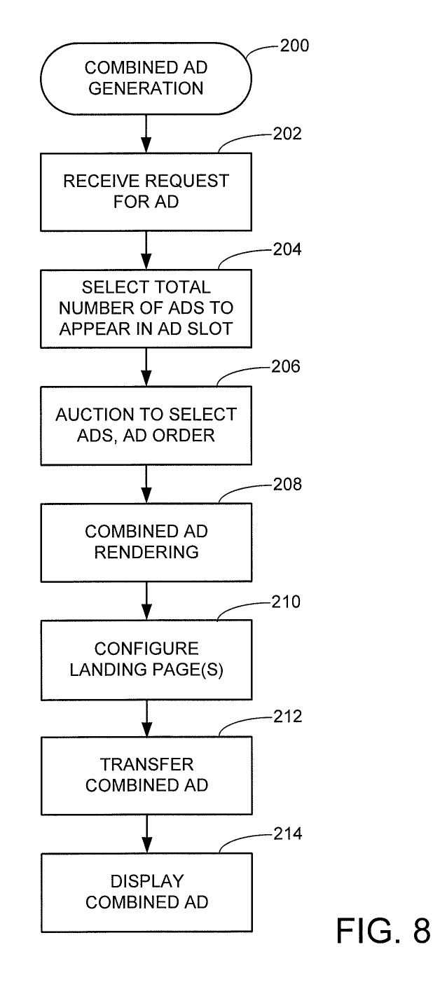

FIG. 7 shows example server-side modules that operate to render a combined ad. Parametric inputs are provided to a number of ads selection module 142. The number of ads selection module 142 can determine, based on the pixel size of the ad slot specified by the ad request, a visually optimal number of mobile app icons to be shown in the ad slot. For instance, the ad slot size is nominally 320 pixels by 50 pixels, and the number of ads displayed in the ad slot is at least three.

The number of ads selection module 142 can interact with the auction engine 144 to select the ads to be displayed. The ads, presentation order of the ads for display, or a combination of both may be selected for the combined ad by performing a computer-automated auction based on a cost-to-click value assigned to each ad. At least one of the selected ads may be a click to download item, a click to call item, a click to chapter item or a click to purchase item.

The auction engine 144 can interact with the ad rendering module 146 to provide the combined ad that will be displayed on the device 102 (see FIG. 1). Rendering a combined ad incorporates the selected plurality of ads to fit within the ad slot. The combined ad may be transferred to the network accessible device and displayed on the device during execution of the selected application.

The auction engine 144 can compute the collective Max_eCPM (Expected Cost Per Mille) of the ad slot showing N recommended apps as follows:

$$Max\_eCPM ( multi \text{-} app ad slot ) = {\sum }_{i = 1}^{ N} Max [ {\backslash}_{?} ] eCPM ( {App}_{i} )$$

$$with$$

$$Max [ {\backslash}_{?} ] eCPM ( {App}_{i} ) = MaxCPC ( {App}_{i} ) \times pCTR ( {App}_{i} ) \times PositionNormalizationMultiplier ( i )$$

In the equations above: i is the index of the position of app icons in the ad slot. In particular, i=1 represents the most prominent position whereas i=N represents the least prominent position.

MaxCPC(Appᵢ) is the max CPC (Cost Per Click) the advertiser of is willing to pay for an ad click on the app.

pCTR(Appᵢ) is the predicted CTR (Click Through Rate) of Appᵢ, i.e., the probability the end user clicks on Appᵢ to visit its download page in an app store/market, if hypothetically Appᵢ is displayed in position i=1, i.e., the most prominent position.

PositionNormalizationMultiplier(i) is a real number in [0, 1]. It is 1.0 for i=1, i.e., the most prominent position in the ad slot, and a number less than 1.0 for less prominent positions. This multiplier captures the relative CTR difference between an i>1 position and the most prominent position, even if the app shown in this position would have the same CTR had it been shown in the most prominent position.

The auction engine 144 can compare the ‘Max_eCPM(multi-app ad slot)’ against an Max eCPM of other ads in the system, which either individually fill up the entire ad slot space, or collectively as a set that takes up the ad slot. If the ‘Max_eCPM(multi-app ad slot)’ is the largest among all these Max eCPM values, then the auction system may declare the ad slot with the combined ad as the final auction winner, and the rendered combined ad is transferred to the network accessible device.

Advertisers can be charged for each mobile app in the ad slot. For example, in a first-price auction model an advertiser behind Appᵢ is charged with MaxCPC(Appᵢ), i.e., the advertiser-specified max CPC.

In another embodiment that uses a second-price auction model, the advertiser for Appᵢ pays

$$PaidCPC ( {App}_{i} ) = MaxCPC ( {App}_{i} ) \times AuctionDiscount$$

$$and$$

$$AuctionDiscount = \frac{Max [ {\backslash}_{?} ] eCPM ( The runner \text{-} up ad that lost the auction )}{Max [ {\backslash}_{?} ] eCPM ( The multi \text{-} app ad slot , aka , the winner )}$$

In other words, under the second price auction model, the auction discount between the winner and the runner-up may be evenly distributed to each advertiser participating in the ad slot with the combined ad.

FIG. 8 provides a flow chart for a COMBINED AD GENERATION routine 200 illustrative of various steps that may be carried out in accordance with the foregoing discussion.

At step 202, a request is received in a memory for a mobile ad for display in an ad slot on the GUI 112 of the network accessible device 102 (FIGS. 1-2). The request may be received from the device. The request may be for an advertisement to be displayed in conjunction with an application executing on the device.

At step 204, a plural number of ads is selected from a database of available ads in a memory responsive to factors for selection of N selected ads. The factors may include request for ad, ad slot size, currently executed app (such as the selected mobile app), device level profile info, server level profile info, or other appropriate factors.

At step 206, the ads and the ad presentation order may be selected for the combined ads by performance of a computer-automated auction based on a cost-to-click value assigned to each ad. The auction engine provides the combined ad that will be displayed on the device 102.

At step 208, the combined ad is rendered to incorporate the selected plurality of ads to fit within the ad slot. The number of ads and the size of the ad slot are used to render the combined ads that are legible and inviting to the user to “click.”

At step 210, one or more landing pages are configured for the combined ads. The landing pages may extend a plurality of invitations to action by the user for different combinations of the selected ads in the combined ad established responsive to selection of the combined ad. A different landing page is configured for each of the different ones of the plurality of interactive action portions for each of the selected ads.

At step 212, the combined ad is transferred from the server through the network to the network accessible device.

At step 214, the combined ad is displayed on the network accessible device. The user may “click” on the interactive portion of the ads to select the ad. The user may “click” on the advertisement by moving a pointer, activating a user button on the device, tapping on a touch screen, or performing some other interactive operation via the GUI to signify acceptance. Alternatively, the user may be given an opportunity to enter information such as making selections or entering text as part of the accepted invitation. The appropriate landing page is displayed responsive to the user selection.

While the foregoing discussion has contemplated the apps in the combined ads as an advertisement, such is merely illustrative and not limiting. The app to take action may take any variety of forms such as a public service announcement, an advertisement for a political candidate, an opportunity to contribute to a social movement or relief fund, a request to sign a petition or other organized activity, an invitation to comment upon or indicate approval of the first app in a social network, an offer to purchase a physical item such as a book or movie tickets, and so on.

It is to be understood that even though numerous characteristics and advantages of various embodiments of the present invention have been set forth in the foregoing description, together with details of the structure and function of various embodiments of the invention, this detailed description is illustrative only, and changes may be made in detail, especially in matters of structure and arrangements of parts within the principles of the present invention to the full extent indicated by the broad general meaning of the terms in which the appended claims are expressed.

What is claimed is:

1. A computer-implemented method comprising:
receiving a request in a memory for a mobile advertisement (ad) for display in an ad slot on a graphical user interface (GUI) of a network accessible device;
selecting a total plural number of ads from a database of available ads in a memory responsive to a size of the ad slot on the GUI;
rendering a combined ad that combines the total plural number of selected ads; and
transferring the combined ad for display in said ad slot.

2. The method of claim 1, in which at least one of the selected ads is a click to download item, a click to call item, a click to chat item or a click to purchase item.

3. The method of claim 1, in which the request is generated responsive to execution of an application on the network accessible device and the combined ad is displayed during said execution of the application.

4. The method of claim 1, in which the ads are selected for the combined ad responsive to device level profile information transmitted with the request.

5. The method of claim 1, in which the ads are selected for the combined ad responsive to server level profile information associated with the device.

6. The method of claim 1, in which the ad slot size is nominally 320 pixels by 50 pixels.

7. The method of claim 1, in which the ad slot size is nominally 640 pixels by 100 pixels.

8. The method of claim 1, in which the ads are selected for the combined ad by performing a computer-automated auction based on a cost-to-click value assigned to each ad.

9. The method of claim 1, further comprising generating a landing page for display on the device GUI responsive to user selection of the combined ad.

10. The method of claim 9, in which the landing page extends a plurality of invitations to action by the user for different combinations of the selected ads in the combined ad established responsive to user selection of the combined ad.

11. The method of claim 9, in which the combined ad has a plurality of interactive action portions, one for each of the selected ads, and a different landing page is displayed responsive to user selection of different ones of the plurality of interactive action portions.

12. A computer-implemented method comprising:
receiving, from a network accessible device, a request for an advertisement (ad) to be displayed in conjunction with an application executing on the network accessible device;
responsive to the request, selecting a plurality of ads from a database of available ads stored in a memory in relation to a display size associated with the request;
rendering a combined ad that incorporates the selected plurality of ads to fit within the display size;
generating at least one landing page adapted for display responsive to user selection of the ad; and
transferring, to the network accessible device, the combined ad for display thereon.

13. The method of claim 12, in which the request is generated by an application during execution thereof on the network accessible device, and the combined ad is displayed during said execution.

14. The method of claim 12, in which the landing page extends a plurality of invitations to action by the user for different combinations of the selected ads in the combined ad established responsive to user selection of the combined ad.

15. The method of claim 12, in which the combined ad has a plurality of interactive action portions, one for each of the selected ads, and a different landing page is displayed responsive to user selection of different ones of the plurality of interactive action portions.

16. The method of claim 12, in which the ads are selected for the combined ad by performing a computer-automated auction based on a cost-to-click value assigned to each ad.

17. The method of claim 12, in which the ads are selected for the combined ad responsive to device level profile information transmitted with the request.

18. The method of claim 12, in which the ads are selected for the combined ad responsive to server level profile information associated with the device.

19. An apparatus comprising:
a processor; and
a memory which stores programming for the processor adapted to, responsive to receipt of a request from a network accessible device for an advertisement (ad) to be displayed in conjunction with an application executing on the network accessible device, perform steps of:
selecting a plurality of ads from a database of available ads stored in a memory in relation to an ad slot size associated with the request;
rendering a combined ad that incorporates the selected plurality of ads to fit within the ad slot;
generating at least one landing page adapted for display responsive to user selection of the ad; and
transferring, to the network accessible device, the combined ad for display thereon.

20. The apparatus of claim 19, in which the request is generated by an application during execution thereof on the network accessible device, and the combined ad is adapted for display during said execution.

21. The apparatus of claim 19, in which the landing page extends a plurality of invitations to action by the user for different combinations of the selected ads in the combined ad established responsive to user selection of the combined ad.

22. The apparatus of claim 19, in which the combined ad has a plurality of interactive action portions, one for each of the selected ads, and a different landing page is displayed responsive to user selection of different ones of the plurality of interactive action portions.

23. The apparatus of claim 19, in which the ads are selected for the combined ad by performing a computer-automated auction based on a cost-to-click value assigned to each ad.

24. The apparatus of claim 19, in which the ads are selected for the combined ad responsive to profile information associated with the device.

25. The apparatus of claim 19, in which the ad slot size is nominally 320 pixels by 50 pixels, and the number of ads displayed in said slot is at least three.
